(19) United States
(12) Patent Application Publication
(10) Pub. No.: US 2022/0256557 A1
(43) Pub. Date: Aug. 11, 2022

(54) COMMUNICATION APPARATUSES AND COMMUNICATION METHODS FOR DCI FOR V2X COMMUNICATION APPARATUSES

(71) Applicant: Panasonic Intellectual Property Corporation of America, Torrance, CA (US)

(72) Inventors: Yang KANG, Singapore (SG); Tien Ming Benjamin KOH, Singapore (SG); Lei HUANG, Singapore (SG); Xuan Tuong TRAN, Singapore (SG); Yihui LI, Singapore (SG); Anitha ARUN PRASAD, Singapore (SG)

(21) Appl. No.: 17/629,743

(22) PCT Filed: Jun. 25, 2020
(86) PCT No.: PCT/SG2020/050358

§ 371 Date: Jan. 24, 2022

(30) Foreign Application Priority Data
Jul. 31, 2019 (SG) 10201907070S

(51) Int. Cl. H04W 72/12; H04W 72/02

(52) U.S. Cl. CPC H04W 72/121; H04W 72/02; H04W 72/1289; H04W 72/1263

(57) ABSTRACT

The present disclosure provides communication apparatuses and communication methods for DCI for V2X communication apparatuses. The communication apparatuses include a base station which comprises circuitry, which, in operation, generates a message indicating whether or not a communication apparatus is on a receiving mode; and a transmitter, which, in operation, transmits the message to the communication apparatus.

### TECHNICAL FIELD

The following disclosure relates to communication apparatuses and communication methods for New Radio (NR) communications, and more particularly to communication apparatuses and communication methods for Downlink Control Information (DCI) for V2X communication apparatuses.

### BACKGROUND

V2X communication allows vehicles to interact with public roads and other road users, and is thus considered a critical factor in making autonomous vehicles a reality.

To accelerate this process, 5G NR based V2X communications (interchangeably referred to as NR V2X communications) is being discussed by the 3rd Generation Partnership Project (3GPP) to identify technical solutions for advanced V2X services, through which vehicles (i.e. interchangeably referred to as communication apparatuses or user equipments (UEs) that support V2X applications) can exchange their own status information through sidelink (SL) with other nearby vehicles, infrastructure nodes and/or pedestrians. The status information includes information on position, speed, heading, etc.

In such V2X communications, there are at least two SL resource allocation modes being discussed by the 3GPP. In resource allocation Mode 1, SL resource(s) to be used by a UE for SL transmissions are scheduled by a base station (BS). In resource allocation Mode 2, the UE determines, i.e. the BS does not schedule, SL transmission resources within the SL resources configured by the BS/network or pre-configured SL resources. The 3GPP study on resource allocation also considers sensing and resource selection procedures for a Mode 2(a), in the context of a semi-persistent scheme where resource(s) are selected for multiple transmissions of different transmission blocks (TBs) and a dynamic scheme where resource(s) are selected for each TB transmission.

In the Work Item Description (WID) on 5G V2X with NR sidelink as discussed in document RP-190766 of the 3GPP TSG RAN Meeting #83, the following items were considered:
Specify NR sidelink solutions necessary to support sidelink unicast, sidelink groupcast, and sidelink broadcast for V2X services, considering in-network coverage, out-of-network coverage, and partial network coverage.
Mode 1: NR sidelink scheduling by NR Uu and LTE Uu as per the study outcome, where Uu refers to the logical interface between the UE and the base station.
Mode 2: Sensing and resource selection procedures based on sidelink pre-configuration and configuration by NR Uu and LTE Uu as per the study outcome.
Support for simultaneous configuration of Mode 1 and Mode 2 for a UE:
   Transmitter UE operation in this configuration is to be discussed after the design of mode 1 only and mode 2 only.
   Receiver UE can receive the transmissions without knowing the resource allocation mode used by the transmitter UE.

However, there has been no discussion on communication apparatuses and methods for DCI for V2X communication apparatuses.

There is thus a need for communication apparatuses and methods that provide feasible technical solutions for DCI for V2X communication apparatuses. Furthermore, other desirable features and characteristics will become apparent from the subsequent detailed description and the appended claims, taken in conjunction with the accompanying drawings and this background of the disclosure.

### SUMMARY

Non-limiting and exemplary embodiment facilitates providing communication apparatuses and methods for DCI for V2X communication apparatuses.

According to a first embodiment of the present disclosure, there is provided a communication apparatus comprising: a receiver, which, in operation, receives a message indicating whether or not the communication apparatus is on a receiving mode; and a transmitter, which, in operation, transmits a signal when the communication apparatus is not on the receiving mode.

According to a second embodiment of the present disclosure, there is provided a base station comprising: circuitry, which, in operation, generates a message indicating whether or not a communication apparatus is on a receiving mode; and a transmitter, which, in operation, transmits the message to the communication apparatus.

According to a third embodiment of the present disclosure, there is provided a communication method comprising: generating a message indicating whether or not a communication apparatus is on a receiving mode; and transmitting the message to the communication apparatus.

It should be noted that general or specific embodiments may be implemented as a system, a method, an integrated circuit, a computer program, a storage medium, or any selective combination thereof.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

Embodiments of the disclosure will be better understood and readily apparent to one of ordinary skilled in the art from the following written description, by way of example only, and in conjunction with the drawings, in which:

FIG. 1 shows an exemplary architecture for a 3GPP NR system.

FIG. 2 is a schematic drawing which shows functional split between NG-RAN and 5GC.

FIG. 3 is a sequence diagram for RRC connection setup/reconfiguration procedures.

FIG. 4 is a schematic drawing showing usage scenarios of Enhanced mobile broadband (eMBB), Massive Machine Type Communications (mMTC) and Ultra Reliable and Low Latency Communications (URLLC).

FIG. 5 is a block diagram showing an exemplary 5G system architecture for a non-roaming scenario.

FIG. 6 depicts a schematic diagram 100 illustrating how a gNode B (gNB) or base station typically utilises DCI (i.e. DCI_X) in V2X communications.

FIG. 7 depicts a schematic diagram 200 illustrating how a gNB or base station utilises a DCI_Y in V2X communications according to various embodiments.

FIG. 8 depicts a message flow 300 illustrating how a gNB or base station utilises the DCI_Y in V2X communications according to various embodiments.

FIG. 9 depicts a schematic diagram 400 illustrating how a gNB or base station utilises the DCI_Y for groupcast in V2X communications according to various embodiments.

FIG. 10 depicts a schematic diagram 1000 illustrating how a gNB or base station utilises the DCI_X as the DCI_Y in V2X communications according to various embodiments.

FIG. 11 depicts a schematic diagram 1100 illustrating how a gNB or base station utilises the DCI_Y for broadcast in V2X communications according to various embodiments.

FIG. 12 depicts a schematic diagram 1200 illustrating another example of how a gNB or base station utilises the DCI_Y in V2X communications according to various embodiments.

FIG. 13 shows a format of a typical DCI_X message according to various embodiments.

FIG. 14 shows a format of a DCI_Y message according to various embodiments.

FIG. 15 shows an example of how a receiving window is indicated in a DCI_Y message according to various embodiments.

FIG. 16 shows another example of how a receiving window is indicated in a DCI_Y message according to various embodiments.

FIG. 17 shows another example of how a receiving window is indicated in a DCI_Y message according to various embodiments.

FIG. 18 shows another example of how a receiving window is indicated in a DCI_Y message according to various embodiments.

FIG. 19 shows another example of how a receiving window is indicated in a DCI_Y message according to various embodiments.

FIG. 20 shows a flow diagram illustrating a communication method according to various embodiments.

FIG. 21 shows a schematic example of communication apparatus in accordance with various embodiments. The communication apparatus may be implemented as an UE or a gNB/base station and configured for DCI for V2X communications in accordance with various embodiments of the present disclosure.

Skilled artisans will appreciate that elements in the figures are illustrated for simplicity and clarity and have not necessarily been depicted to scale. For example, the dimensions of some of the elements in the illustrations, block diagrams or flowcharts may be exaggerated in respect to other elements to help to improve understanding of the present embodiments.

### DETAILED DESCRIPTION

Some embodiments of the present disclosure will be described, by way of example only, with reference to the drawings. Like reference numerals and characters in the drawings refer to like elements or equivalents.

5G NR System Architecture and Protocol Stacks

3GPP has been working at the next release for the 5th generation cellular technology, simply called 5G, including the development of a new radio access technology (NR) operating in frequencies ranging up to 100 GHz. The first version of the 5G standard was completed at the end of 2017, which allows proceeding to 5G NR standard-compliant trials and commercial deployments of smartphones.

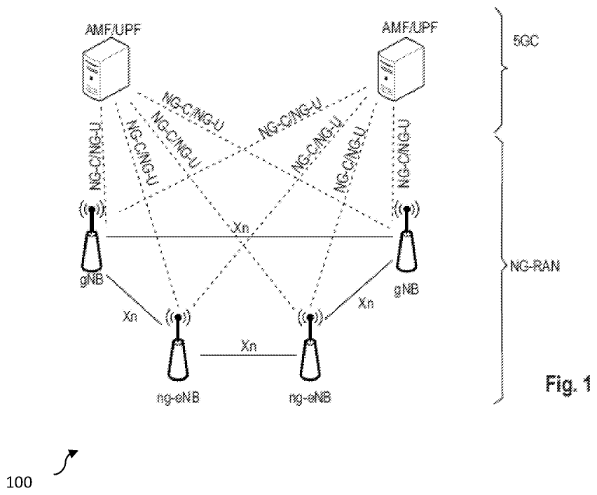

Among other things, the overall system architecture assumes an NG-RAN (Next Generation-Radio Access Network) that comprises gNBs, providing the NG-radio access user plane (SDAP/PDCP/RLC/MAC/PHY) and control plane (RRC) protocol terminations towards the UE. The gNBs are interconnected with each other by means of the Xn interface. The gNBs are also connected by means of the Next Generation (NG) interface to the NGC (Next Generation Core), more specifically to the AMF (Access and Mobility Management Function) (e.g. a particular core entity performing the AMF) by means of the NG-C interface and to the UPF (User Plane Function) (e.g. a particular core entity performing the UPF) by means of the NG-U interface. The NG-RAN architecture is illustrated in FIG. 1 (see e.g. 3GPP TS 38.300 v15.6.0, section 4).

The user plane protocol stack for NR (see e.g. 3GPP TS 38.300, section 4.4.1) comprises the PDCP (Packet Data Convergence Protocol, see section 6.4 of TS 38.300), RLC (Radio Link Control, see section 6.3 of TS 38.300) and MAC (Medium Access Control, see section 6.2 of TS 38.300) sublayers, which are terminated in the gNB on the network side. Additionally, a new access stratum (AS) sublayer (SDAP, Service Data Adaptation Protocol) is introduced above PDCP (see e.g. sub-clause 6.5 of 3GPP TS 38.300). A control plane protocol stack is also defined for NR (see for instance TS 38.300, section 4.4.2). An overview of the Layer 2 functions is given in sub-clause 6 of TS 38.300. The functions of the PDCP, RLC and MAC sublayers are listed respectively in sections 6.4, 6.3, and 6.2 of TS 38.300. The functions of the RRC layer are listed in sub-clause 7 of TS 38.300.

For instance, the Medium-Access-Control layer handles logical-channel multiplexing, and scheduling and scheduling-related functions, including handling of different numerologies.

The physical layer (PHY) is for example responsible for coding, PHY HARQ processing, modulation, multi-antenna processing, and mapping of the signal to the appropriate physical time-frequency resources. It also handles mapping of transport channels to physical channels. The physical layer provides services to the MAC layer in the form of transport channels. A physical channel corresponds to the set of time-frequency resources used for transmission of a particular transport channel, and each transport channel is mapped to a corresponding physical channel. For instance, the physical channels are PRACH (Physical Random Access Channel), PUSCH (Physical Uplink Shared Channel) and PUCCH (Physical Uplink Control Channel) for uplink and PDSCH (Physical Downlink Shared Channel), PDCCH (Physical Downlink Control Channel) and PBCH (Physical Broadcast Channel) for downlink.

Use cases/deployment scenarios for NR could include enhanced mobile broadband (eMBB), ultra-reliable low-latency communications (URLLC), massive machine type communication (mMTC), which have diverse requirements in terms of data rates, latency, and coverage. For example, eMBB is expected to support peak data rates (20 Gbps for downlink and 10 Gbps for uplink) and user-experienced data rates in the order of three times what is offered by IMT-Advanced. On the other hand, in case of URLLC, the tighter requirements are put on ultra-low latency (0.5 ms for UL and DL each for user plane latency) and high reliability (1-10-5 within 1 ms). Finally, mMTC may preferably require high connection density (1,000,000 devices/km2 in an urban environment), large coverage in harsh environments, and extremely long-life battery for low cost devices (15 years).

Therefore, the OFDM numerology (e.g. subcarrier spacing, OFDM symbol duration, cyclic prefix (CP) duration, number of symbols per scheduling interval) that is suitable for one use case might not work well for another. For example, low-latency services may preferably require a shorter symbol duration (and thus larger subcarrier spacing) and/or fewer symbols per scheduling interval (aka, TTI) than an mMTC service. Furthermore, deployment scenarios with large channel delay spreads may preferably require a longer CP duration than scenarios with short delay spreads. The subcarrier spacing should be optimized accordingly to retain the similar CP overhead. NR may support more than one value of subcarrier spacing. Correspondingly, subcarrier spacing of 15 kHz, 30 kHz, 60 kHz . . . are being considered at the moment. The symbol duration Tu and the subcarrier spacing Δf are directly related through the formula Δf=1/Tu. In a similar manner as in LTE systems, the term “resource element” can be used to denote a minimum resource unit being composed of one subcarrier for the length of one OFDM/SC-FDMA symbol.

In the new radio system 5G-NR for each numerology and carrier a resource grid of subcarriers and OFDM symbols is defined respectively for uplink and downlink. Each element in the resource grid is called a resource element and is identified based on the frequency index in the frequency domain and the symbol position in the time domain (see 3GPP TS 38.211 v15.6.0).

5G NR Functional Split Between NG-RAN and 5GC

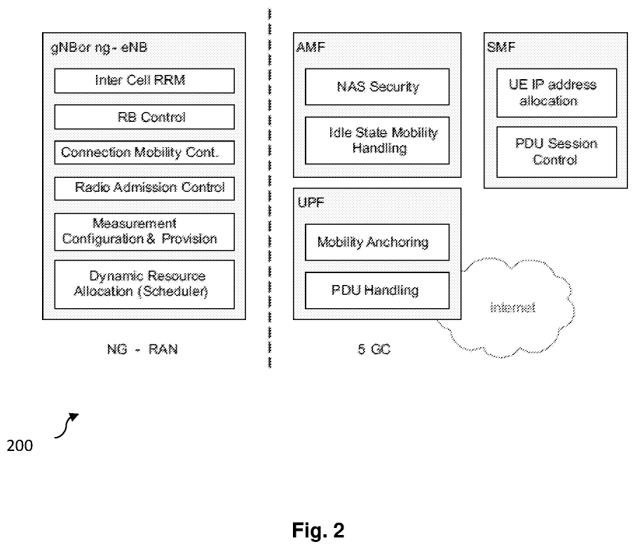

FIG. 2 illustrates functional split between NG-RAN and 5GC. NG-RAN logical node is a gNB or ng-eNB. The 5GC has logical nodes AMF, UPF and SMF.

In particular, the gNB and ng-eNB host the following main functions:
Functions for Radio Resource Management such as Radio Bearer Control, Radio Admission Control, Connection Mobility Control, Dynamic allocation of resources to UEs in both uplink and downlink (scheduling);
IP header compression, encryption and integrity protection of data;
Selection of an AMF at UE attachment when no routing to an AMF can be determined from the information provided by the UE;
Routing of User Plane data towards UPF(s);
Routing of Control Plane information towards AMF;
Connection setup and release;
Scheduling and transmission of paging messages;
Scheduling and transmission of system broadcast information (originated from the AMF or OAM);
Measurement and measurement reporting configuration for mobility and scheduling;
Transport level packet marking in the uplink;
Session Management;
Support of Network Slicing;
QoS Flow management and mapping to data radio bearers;
Support of UEs in RRC_INACTIVE state;
Distribution function for NAS messages;
Radio access network sharing;
Dual Connectivity;
Tight interworking between NR and E-UTRA.

The Access and Mobility Management Function (AMF) hosts the following main functions:
Non-Access Stratum, NAS, signaling termination;
NAS signaling security;
Access Stratum, AS, Security control;
Inter Core Network, CN, node signaling for mobility between 3GPP access networks;
Idle mode UE Reachability (including control and execution of paging retransmission);
Registration Area management;
Support of intra-system and inter-system mobility;
Access Authentication;
Access Authorization including check of roaming rights;
Mobility management control (subscription and policies);
Support of Network Slicing;
Session Management Function, SMF, selection.
   Furthermore, the User Plane Function, UPF, hosts the following main functions:
Anchor point for Intra-/Inter-RAT mobility (when applicable);
External PDU session point of interconnect to Data Network;
Packet routing & forwarding;
Packet inspection and User plane part of Policy rule enforcement;
Traffic usage reporting;
Uplink classifier to support routing traffic flows to a data network;
Branching point to support multi-homed PDU session;
QoS handling for user plane, e.g. packet filtering, gating, UL/DL rate enforcement;
Uplink Traffic verification (SDF to QoS flow mapping);
Downlink packet buffering and downlink data notification triggering.
   Finally, the Session Management function, SMF, hosts the following main functions:
Session Management;
UE IP address allocation and management;
Selection and control of UP function;
Configures traffic steering at User Plane Function, UPF, to route traffic to proper destination;
Control part of policy enforcement and QoS;
Downlink Data Notification.

RRC Connection Setup and Reconfiguration Procedures

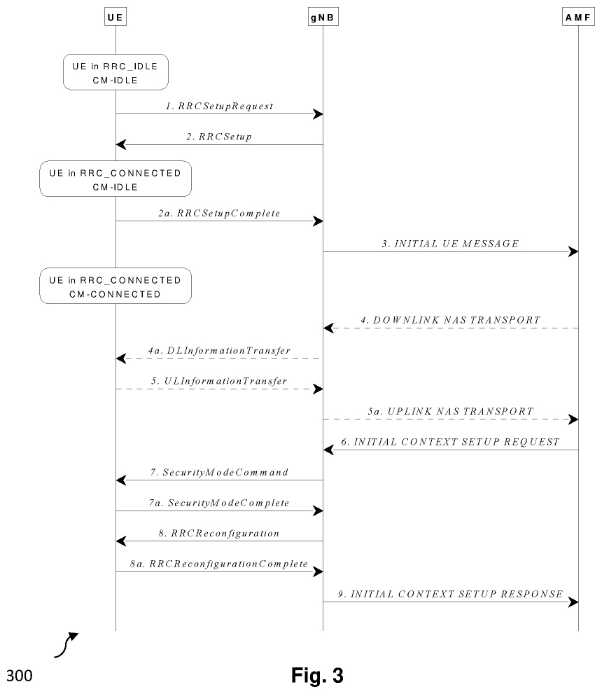

FIG. 3 illustrates some interactions between a UE, gNB, and AMF (an 5GC entity) in the context of a transition of the UE from RRC_IDLE to RRC_CONNECTED for the NAS part (see TS 38.300 v15.6.0).

RRC is a higher layer signaling (protocol) used for UE and gNB configuration. In particular, this transition involves that the AMF prepares the UE context data (including e.g. PDU session context, the Security Key, UE Radio Capability and UE Security Capabilities, etc.) and sends it to the gNB with the INITIAL CONTEXT SETUP REQUEST. Then, the gNB activates the AS security with the UE, which is performed by the gNB transmitting to the UE a SecurityModeCommand message and by the UE responding to the gNB with the SecurityModeComplete message. Afterwards, the gNB performs the reconfiguration to setup the Signaling Radio Bearer 2, SRB2, and Data Radio Bearer(s), DRB(s) by means of transmitting to the UE the RRCReconfiguration message and, in response, receiving by the gNB the RRCReconfigurationComplete from the UE. For a signaling-only connection, the steps relating to the RRCReconfiguration are skipped since SRB2 and DRBs are not setup. Finally, the gNB informs the AMF that the setup procedure is completed with the INITIAL CONTEXT SETUP RESPONSE.

In the present disclosure, thus, an entity (for example AMF, SMF, etc.) of a 5th Generation Core (5GC) is provided that comprises control circuitry which, in operation, establishes a Next Generation (NG) connection with a gNodeB, and a transmitter which, in operation, transmits an initial context setup message, via the NG connection, to the gNodeB to cause a signaling radio bearer setup between the gNodeB and a user equipment (UE). In particular, the gNodeB transmits a Radio Resource Control, RRC, signaling containing a resource allocation configuration information element to the UE via the signaling radio bearer. The UE then performs an uplink transmission or a downlink reception based on the resource allocation configuration.

Usage Scenarios of IMT for 2020 and Beyond

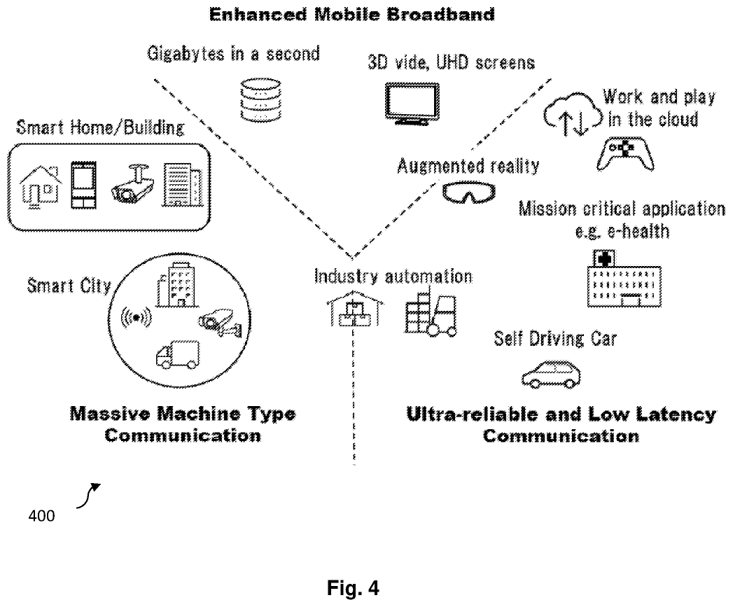

FIG. 4 illustrates some of the use cases for 5G NR. In 3rd generation partnership project new radio (3GPP NR), three use cases are being considered that have been envisaged to support a wide variety of services and applications by IMT-2020. The specification for the phase 1 of enhanced mobile-broadband (eMBB) has been concluded. In addition to further extending the eMBB support, the current and future work would involve the standardization for ultra-reliable and low-latency communications (URLLC) and massive machine-type communications. FIG. 4 illustrates some examples of envisioned usage scenarios for IMT for 2020 and beyond (see e.g. ITU-R M.2083 FIG. 2).

The URLLC use case has stringent requirements for capabilities such as throughput, latency and availability and has been envisioned as one of the enablers for future vertical applications such as wireless control of industrial manufacturing or production processes, remote medical surgery, distribution automation in a smart grid, transportation safety, etc. Ultra-reliability for URLLC is to be supported by identifying the techniques to meet the requirements set by TR 38.913. For NR URLLC in Release 15, key requirements include a target user plane latency of 0.5 ms for UL (uplink) and 0.5 ms for DL (downlink). The general URLLC requirement for one transmission of a packet is a BLER (block error rate) of 1E-5 for a packet size of 32 bytes with a user plane latency of 1 ms.

From the physical layer perspective, reliability can be improved in a number of possible ways. The current scope for improving the reliability involves defining separate CQI tables for URLLC, more compact DCI formats, repetition of PDCCH, etc. However, the scope may widen for achieving ultra-reliability as the NR becomes more stable and developed (for NR URLLC key requirements). Particular use cases of NR URLLC in Rel. 15 include Augmented Reality/Virtual Reality (AR/VR), e-health, e-safety, and mission-critical applications.

Moreover, technology enhancements targeted by NR URLLC aim at latency improvement and reliability improvement. Technology enhancements for latency improvement include configurable numerology, non slot-based scheduling with flexible mapping, grant free (configured grant) uplink, slot-level repetition for data channels, and downlink pre-emption. Pre-emption means that a transmission for which resources have already been allocated is stopped, and the already allocated resources are used for another transmission that has been requested later, but has lower latency/higher priority requirements. Accordingly, the already granted transmission is pre-empted by a later transmission. Pre-emption is applicable independent of the particular service type. For example, a transmission for a service-type A (URLLC) may be pre-empted by a transmission for a service type B (such as eMBB). Technology enhancements with respect to reliability improvement include dedicated CQI/MCS tables for the target BLER of 1E-5.

The use case of mMTC (massive machine type communication) is characterized by a very large number of connected devices typically transmitting a relatively low volume of non-delay sensitive data. Devices are required to be low cost and to have a very long battery life. From NR perspective, utilizing very narrow bandwidth parts is one possible solution to have power saving from UE perspective and enable long battery life.

As mentioned above, it is expected that the scope of reliability in NR becomes wider. One key requirement to all the cases, and especially necessary for URLLC and mMTC, is high reliability or ultra-reliability. Several mechanisms can be considered to improve the reliability from radio perspective and network perspective. In general, there are a few key potential areas that can help improve the reliability. Among these areas are compact control channel information, data/control channel repetition, and diversity with respect to frequency, time and/or the spatial domain. These areas are applicable to reliability in general, regardless of particular communication scenarios.

For NR URLLC, further use cases with tighter requirements have been identified such as factory automation, transport industry and electrical power distribution, including factory automation, transport industry, and electrical power distribution. The tighter requirements are higher reliability (up to 10⁻⁶ level), higher availability, packet sizes of up to 256 bytes, time synchronization down to the order of a few ps where the value can be one or a few ps depending on frequency range and short latency in the order of 0.5 to 1 ms in particular a target user plane latency of 0.5 ms, depending on the use cases.

Moreover, for NR URLLC, several technology enhancements from the physical layer perspective have been identified. Among these are PDCCH (Physical Downlink Control Channel) enhancements related to compact DCI, PDCCH repetition, increased PDCCH monitoring. Moreover, UCI (Uplink Control Information) enhancements are related to enhanced HARQ (Hybrid Automatic Repeat Request) and CSI feedback enhancements. Also PUSCH enhancements related to mini-slot level hopping and retransmission/repetition enhancements have been identified. The term “mini-slot” refers to a Transmission Time Interval (TTI) including a smaller number of symbols than a slot (a slot comprising fourteen symbols).

QoS Control

The 5G QoS (Quality of Service) model is based on QoS flows and supports both QoS flows that require guaranteed flow bit rate (GBR QoS flows) and QoS flows that do not require guaranteed flow bit rate (non-GBR QoS Flows). At NAS level, the QoS flow is thus the finest granularity of QoS differentiation in a PDU session. A QoS flow is identified within a PDU session by a QoS flow ID (QFI) carried in an encapsulation header over NG-U interface.

For each UE, 5GC establishes one or more PDU Sessions. For each UE, the NG-RAN establishes at least one Data Radio Bearers (DRB) together with the PDU Session, and additional DRB(s) for QoS flow(s) of that PDU session can be subsequently configured (it is up to NG-RAN when to do so), e.g. as shown above with reference to FIG. 3. The NG-RAN maps packets belonging to different PDU sessions to different DRBs. NAS level packet filters in the UE and in the 5GC associate UL and DL packets with QoS Flows, whereas AS-level mapping rules in the UE and in the NG-RAN associate UL and DL QoS Flows with DRBs.

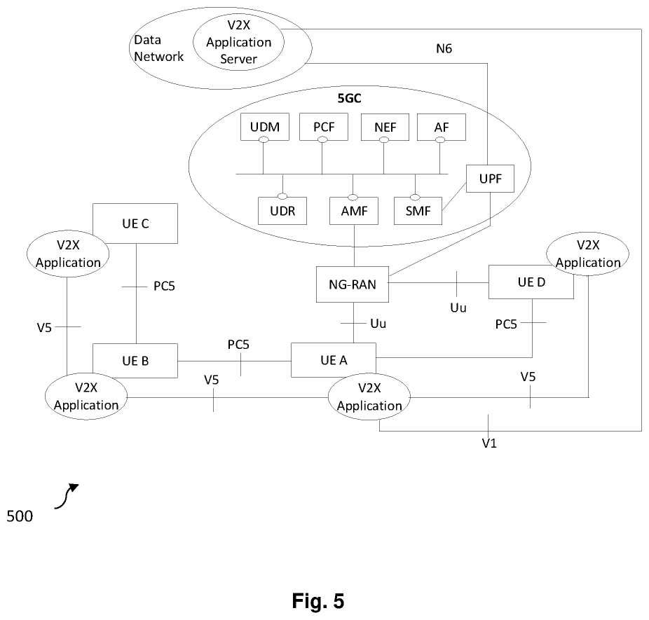

FIG. 5 illustrates a 5G NR non-roaming reference architecture (see TS 23.501 v16.1.0, section 4.23). An Application Function (AF), e.g. an external application server hosting 5G services, exemplarily described in FIG. 4, interacts with the 3GPP Core Network in order to provide services, for example to support application influence on traffic routing, accessing Network Exposure Function (NEF) or interacting with the Policy framework for policy control (see Policy Control Function, PCF), e.g. QoS control. Based on operator deployment, Application Functions considered to be trusted by the operator can be allowed to interact directly with relevant Network Functions. Application Functions not allowed by the operator to access directly the Network Functions use the external exposure framework via the NEF to interact with relevant Network Functions.

FIG. 5 shows further functional units of the 5G architecture, namely Network Slice Selection Function (NSSF), Network Repository Function (NRF), Unified Data Management (UDM), Authentication Server Function (AUSF), Access and Mobility Management Function (AMF), Session Management Function (SMF), and Data Network (DN), e.g. operator services, Internet access or 3rd party services. All of or a part of the core network functions and the application services may be deployed and running on cloud computing environments.

In the present disclosure, thus, an application server (for example, AF of the 5G architecture), is provided that comprises a transmitter, which, in operation, transmits a request containing a QoS requirement for at least one of URLLC, eMMB and mMTC services to at least one of functions (for example NEF, AMF, SMF, PCF, UPF, etc) of the 5GC to establish a PDU session including a radio bearer between a gNodeB and a UE in accordance with the QoS requirement and control circuitry, which, in operation, performs the services using the established PDU session.

For the resource allocation mode 1 where both SL transmitting (Tx) UE and SL receiving (RX) UE(s) are in RRC_CONNECTED mode under coverage of a gNB/base station, the Rx UE(s) may transmit at the same time when the Tx UE is transmitting. This creates a half-duplex issue in which the Rx UE(s) may not be able to receive the transmission from the Tx UE, thus resulting in a waste of radio overhead and transmission power.

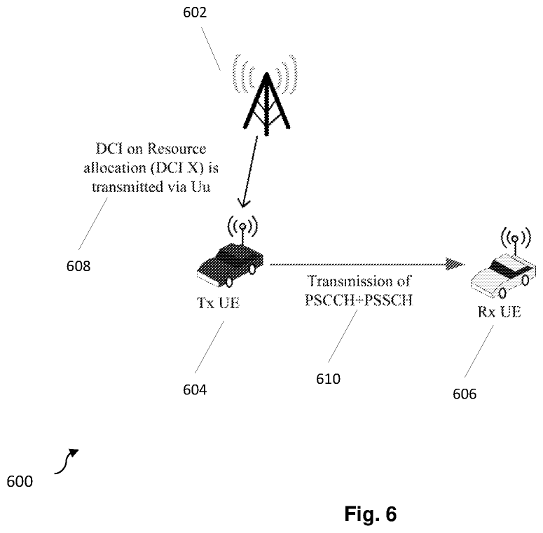

FIG. 6 depicts a schematic diagram 600 illustrating how a gNB or base station typically utilises DCI (i.e. DCI_X) in V2X communications. A base station 602 may transmit a DCI on resource allocation (i.e. a DCI_X 608) via Uu to a Tx UE 604. The DCI_X 608 may comprise resource allocation information that the Tx UE 604 may use to transmit a SL TB 610 to a Rx UE 606. The transmission of the SL TB 610 may be via a Physical Sidelink Shared Channel (PSSCH) and its corresponding control information may be transmitted via a Physical Sidelink Control Channel (PSCCH). The Tx UE 604 and Rx UE 606 may include, for example, communication modules integrated or installed in vehicles subscribed to communication services of one or more telecommunications/PLMN operators.

In the schematic diagram 600, the Tx UE 604 and Rx UE 606 may be subscribed to a telecommunication/PLMN operator operator (not shown) and communicates with the base station 602 of the telecommunication operator. In the present example, the base station 602 may be a next generation NodeB (gNB) 602. It can be appreciated by those skilled in the art that the base station 602 can also be a ng-eNB, and may be connected via the NG interface to a 5G core network.

As mentioned above, if the Rx UE 606 is transmitting at the same time when the Tx UE 604 is transmitting the SL TB 610 to the Rx UE 606, the Rx UE 606 is not able to receive the SL TB 610 from the Tx UE 604.

Therefore, the present invention proposes an improved communication procedure such that the Rx UE is scheduled to receive the transmission from the Tx UE.

In the following paragraphs, certain exemplifying embodiments are explained with reference to a V2X communications mechanism between a gNB/base station and one or more target communication apparatuses that advantageously allows the one or more communication apparatus to avoid missing transmissions from a Tx UE.

For a particular TB to be transmitted in sidelink mode-1, additional to the DCI_X (as DCI_5A in LTE V2X) sent by gNB or base station to the Tx UE for resource allocation, the gNB also schedules the Rx UE(s) with an independent DCI for this TB.

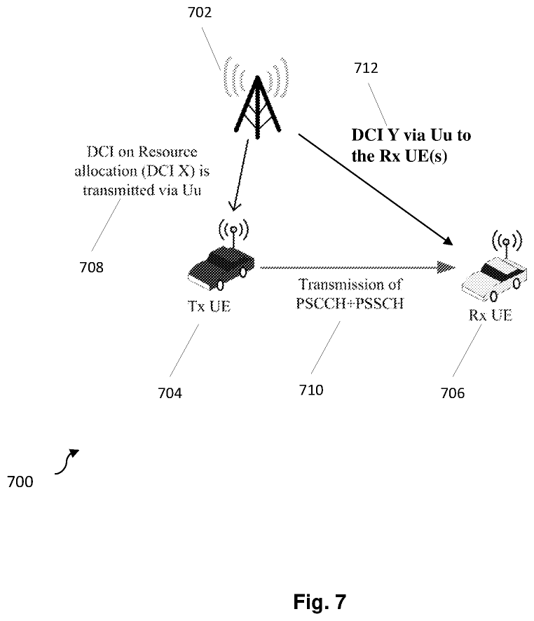

FIG. 7 depicts a schematic diagram 700 illustrating how a gNB or base station utilises a DCI_Y in V2X communications according to various embodiments. In addition to transmitting a DCI_X 708 to Tx UE 704 to provide resource allocation information that the Tx UE 704 may utilise for transmitting a SL TB 710 to Rx UE 706, base station 702 also transmits a message (i.e. DCI_Y 712) to Rx UE 706. The DCI_Y 712 may be a new DCI format that is defined to indicate that the Rx UE 706 is on a receiving mode for the expected SL TB 710. Advantageously, the Rx UE 706 is less likely to miss receiving the SL TB 710, since it would be scheduled to anticipate the transmission of SL TB 710 due to receiving the DCI_Y 712.

For the contents of DCI_X and DCI_Y, the minimum requirements may be defined as the following:
DCI_X: Tx UE identification (ID) information (explicit or implicit) and a time-frequency resource that is granted by the gNB or base station for transmitting the SL TB;
DCI_Y: Rx UE ID information (explicit or implicit) and a “receiving window” of the granted time-frequency resource.
The “receiving window” may at least contain the timing information of the granted time-frequency resource
   Further, the Rx UE(s) should be RRC_CONNECTED to the same gNB or base station as the Tx UE (same or different cells).

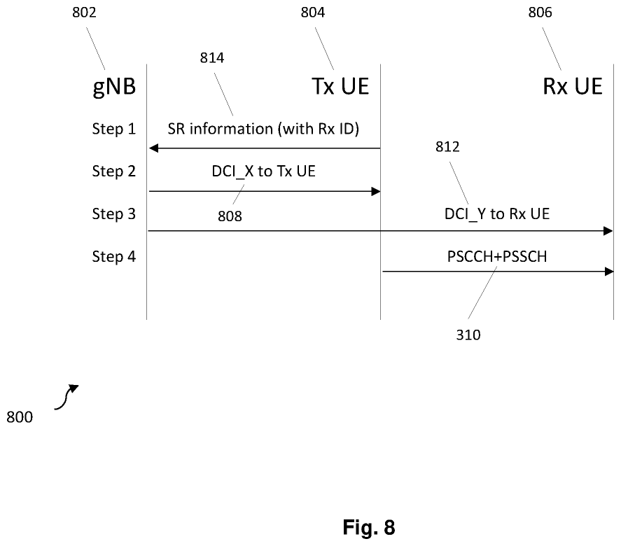

FIG. 8 depicts a message flow 800 illustrating how a gNB or base station utilises the DCI_Y in V2X communications according to various embodiments. For a scenario where a SL TB 810 is to be transmitted by a Tx UE 804 to a Rx UE 806 with, for example, unicast, the Tx UE 804 may first send scheduling information 814 to a serving gNB 802, as shown in step 1 of FIG. 8. The scheduling information 814 may comprise a scheduling request and a report at least containing a destination ID (e.g., Radio Network Temporary Identifier (RNTI), L1/L2 destination ID, etc.) of the Rx UE 806. The gNB 802 may then send a dedicated DCI_X 808 to the Tx UE 804 on resource allocation of the SL TB 810, as shown in step 2 of FIG. 8. The gNB 802 may also send a dedicated DCI_Y 812 to the Rx UE 806 indicating a receiving window for the SL TB 810, as shown in step 3 of FIG. 8. Using the granted resource as indicated in the DCI_X 808, the Tx UE 804 transmits the SL TB 810 on PSSCH, with control information for the SL TB 810 being transmitted on PSCCH, to the Rx UE 806 as shown in step 4 of FIG. 8. The Rx UE 806 would be in receiving-only mode within the receiving window indicated in the DCI_Y 812 so as to receive the transmission of the SL TB 810. Advantageously, the Rx UE 806 is not transmitting when the SL TB 810 is expected and the half-duplex issue is thus avoided.

It will be appreciated that the DCI_Y 812 may be transmitted to the Rx UE 806 earlier, later or at a same time as the transmission of the DCI_X 808 from the gNB 802 to the Tx UE 804. The Tx UE 804 may transmit the TB 810 on PSSCH, with control information for the SL TB 810 being transmitted on PSCCH, to the Rx UE 806 after UE decoding is completed for DCI_X 810 and DCI_Y 812.

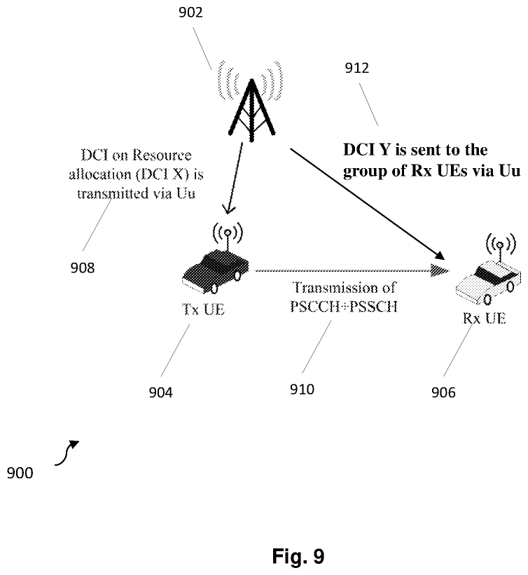

In various embodiments, an SL TB may be scheduled for transmission to a group of Rx UEs with groupcast. FIG. 9 depicts a schematic diagram 900 illustrating how a gNB or base station utilises the DCI_Y for groupcast in V2X communications according to various embodiments. Similar to the examples as shown in FIG. 7 and FIG. 8, Tx UE 904 may first transmit scheduling information to gNB 902. The scheduling information may comprise a scheduling request and a report at least containing a destination group ID which indicates that a SL TB 910 to be transmitted is for groupcast. Based on this information, the gNB 902 may transmit a DCI_X 908 to the Tx UE 904 via Uu for resource scheduling for transmission of the SL TB 910, as well as transmit a message (i.e. DCI_Y 912) via Uu to a group of Rx UEs 906 as identified by the destination group ID to indicate a receiving window for receiving the transmission of the SL TB 910. The group of Rx UEs 906 may be a plurality of UEs. The DCI_Y 912 may be received as a single message directed at the group of Rx UEs 906. In an embodiment, the gNB 902 may also send a plurality of DCI_Y 912 messages, wherein each DCI_Y 912 is transmitted to each of the plurality of Rx UEs 906 within the group to indicate the receiving window for the SL TB 410. Accordingly, the SL TB 910 is then transmitted on PSCCH and PSSCH from the Tx UE 904 to the group of Rx UEs 906, utilising the allocated resource as indicated in DCI_X 908 and within the receiving window as indicated in DCI_Y 912.

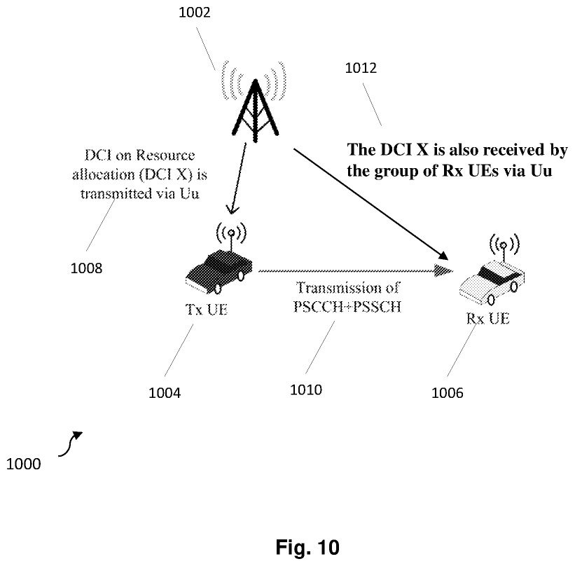

In various embodiments, a DCI_X message may also be sent as a DCI_Y message. FIG. 10 depicts a schematic diagram 1000 illustrating how a gNB or base station may utilise the DCI_X as the DCI_Y in V2X communications according to various embodiments. Similar to the examples as shown in FIG. 8 and FIG. 9, Tx UE 1004 may first transmit scheduling information to gNB 1002. The scheduling information may comprise a scheduling request and a report at least containing a destination ID which indicates that a SL TB 1010 to be transmitted is for groupcast or broadcast. The destination ID may comprise a group ID, a L1/L2 destination ID, a session ID, a service index, etc. Based on this information, the gNB 1002 may transmit a DCI_X 1008 to the Tx UE 1004 via Uu for resource scheduling for transmission of the SL TB 1010. The same DCI_X 1008 may also be transmitted as a DCI_Y 1012 message via Uu to a group of Rx UEs 1006 as identified by the destination ID to indicate a receiving window for receiving the transmission of the SL TB 1010. The group of Rx UEs 1006 may be a plurality of UEs. The DCI_Y 1012 may be received as a single message directed at the group of Rx UEs 1006. In an embodiment, the gNB 502 may also send a plurality of DCI_Y 1012 messages, wherein each DCI_Y 1012 is transmitted to each of the plurality of Rx UEs 1006 within the group to indicate the receiving window for the SL TB 1010. Accordingly, the SL TB 1010 is then transmitted on PSCCH and PSSCH from the Tx UE 1004 to the group of Rx UEs 1006, utilising the allocated resource as indicated in DCI_X 1008 and within the receiving window as indicated in DCI_Y 1012. As the DCI_X 1008 is also utilised as the DCI_Y 1012 message in this embodiment, the DCI_X 1008 may contain both the Tx UE ID and the Rx UE group ID.

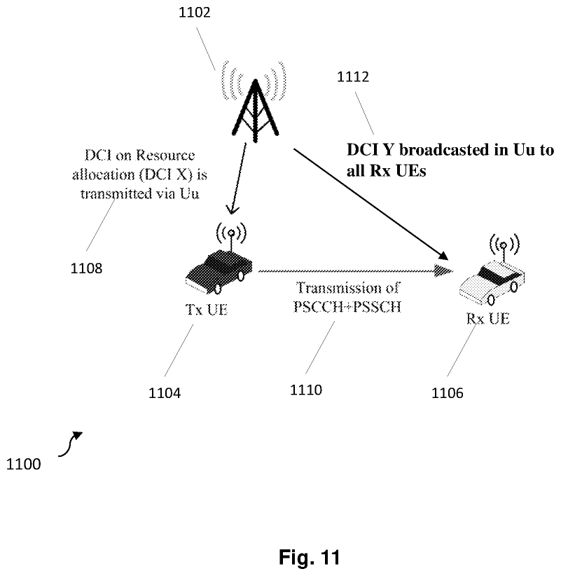

In various embodiments, the SL TB may be scheduled as a broadcast transmission to the intended Rx UEs. FIG. 11 depicts a schematic diagram 1100 illustrating how a gNB or base station utilises the DCI_Y for broadcast in V2X communications according to various embodiments. Similar to the examples as shown in FIG. 8 and FIG. 10, Tx UE 604 may first transmit scheduling information to gNB 1102. The scheduling information may comprise a scheduling request and a report at least containing a destination ID which indicates that a SL TB 1110 to be transmitted is for broadcast with one or more Quality of Service (QoS) parameter/indicator. The one or more QoS parameter/indicator may comprise 5G QoS Identifier (5QI), V2X 5QI (VQI), latency, priority, and other similar indicators. The destination ID may comprise a group ID, a L1/L2 destination ID, a session ID, a service index, etc. Based on this information, the gNB 1102 may transmit a DCI_X 1108 to the Tx UE 1104 via Uu for resource scheduling for transmission of the SL TB 1110, as well as transmit a message (i.e. DCI_Y 1112) as a broadcast to a group of Rx UEs 1106 as identified by the destination ID to indicate at least a receiving window for receiving the transmission of the SL TB 1110. The group of Rx UEs 1106 may be a plurality of UEs. Accordingly, the SL TB 1110 is then transmitted as a broadcast on PSSCH, with control information for the SL TB 1110 being transmitted on PSCCH, from the Tx UE 1104 to the group of Rx UEs 1106, utilising the allocated resource as indicated in DCI_X 1108 and within the receiving window as indicated in DCI_Y 1112.

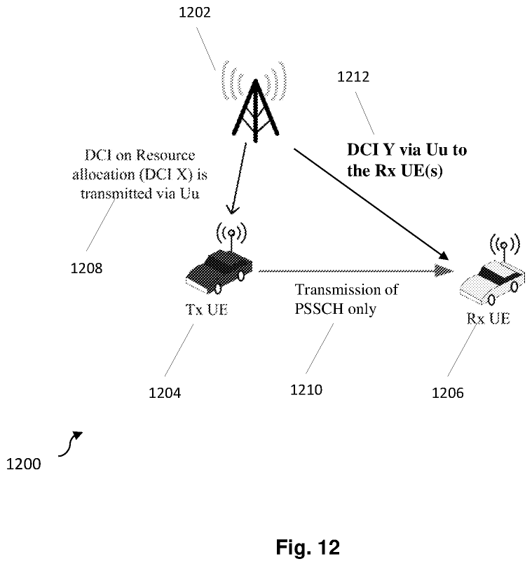

In various embodiments, an SL TB may be scheduled for transmission on PSSCH only. FIG. 12 depicts a schematic diagram 1200 illustrating how a gNB or base station utilises the DCI_Y for SL TB transmission on PSSCH only according to various embodiments. Similar to the examples as shown in FIG. 7 and FIG. 8, Tx UE 1204 may first transmit scheduling information to gNB 1202. The scheduling information may comprise a scheduling request and a report at least containing a destination ID identifying one or more Rx UE(s) 1206. Based on this information, the gNB 1202 may transmit a message (i.e. DCI_Y 1212) via Uu to the one or more Rx UEs 1206 as identified by the destination ID to indicate a receiving window for receiving the transmission of the SL TB 1210. The DCI_Y 1212 may further comprise full information on resource allocation, Modulation and Coding Scheme (MCS), etc of the SL TB 1210 transmission. The gNB 1202 may also transmit a DCI_X 1208 to the Tx UE 1204 via Uu for resource scheduling for transmission of the SL TB 1210, wherein the DCI_X 1208 further comprises information indicating that a DCI_Y (i.e. the DCI_Y 1212) is sent to the Rx UE(s) 1206. It will be appreciated that the DCI_Y 1212 may be transmitted to the Rx UE(s) earlier, later or at the same time as the transmission of the DCI_X 1208 to the Tx UE 1202.

Accordingly, as the DCI_Y 1212 already provides the full information for the resource allocation to the Rx UE(s) 1206, the SL TB 1210 may then be transmitted on PSSCH only from the Tx UE 1204 to the Rx UE(s) 1206, utilising the allocated resource as indicated in DCI_X 1208 and within the receiving window as indicated in DCI_Y 1212. Advantageously, transmission of Sidelink Control Information (SCI) on PSCCH for the SL TB 1210 may be waived to reduce sidelink overhead and transmission power. It will be appreciated that this embodiment may be applicable to unicast, groupcast and broadcast transmissions of SL TB.

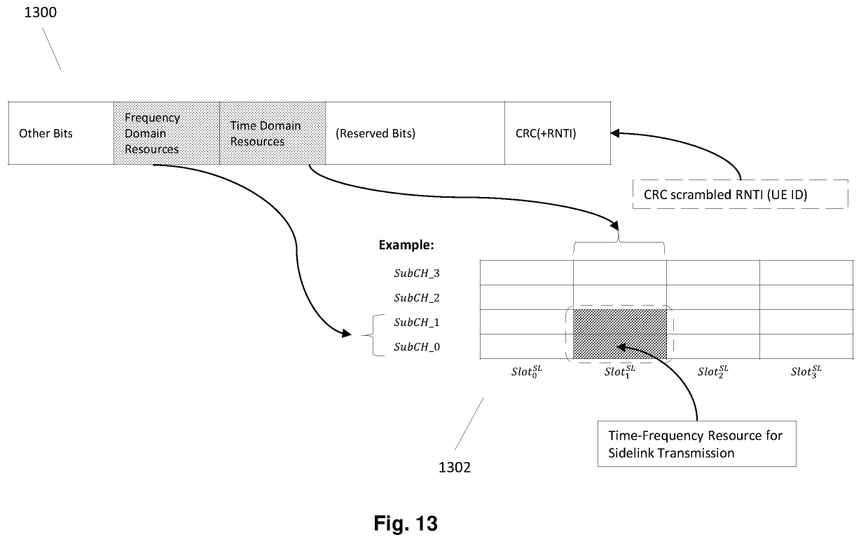

FIG. 13 shows a format of a typical DCI_X 1300 according to various embodiments. The DCI_X 1300 may be transmitted from a gNB or base station to a Tx UE, for example in response to receiving scheduling information from the Tx UE, such as shown in steps 1 and 2 of FIG. 8. The DCI_X 1300 may include (or consist of) a field indicating frequency domain resources, a field indicating time domain resources, a field of bits for other purposes, a field of reserved bits and a field of Cyclic Redundancy Check (CRC) scrambled by RNTI.

The field indicating frequency domain resources may comprise information indicating, for example, one or more subchannels (i.e. SubCH_0 and SubCH_1 as shown in frequency-time resource table 1302). The granularity in the frequency domain may be in a form of resource blocks (RB) or subchannel. In the frequency domain, 3GPP may define a subchannel as several contiguous RBs, where 1 RB may comprise 12 consecutive subcarriers. Each subcarrier spacing may be 2^{μ}*15 kHz, where μ is an integer representing numerology.

The field indicating time domain resources may comprise information indicating, for example, one or more timeslots (i.e. Slot₁^{SL} as shown in frequency-time resource table 1302). The granularity in the time domain may be in a form of subframe, slot, or Orthogonal Frequency Division Multiplexing (OFDM) symbols. In the time domain, 3GPP may define 1 frame as 10 ms, and 1 subframe as 1 ms, where there may be 2^{μ} slots in 1 subframe. Further, there may be 14 OFDM symbols per slot for normal cyclic prefix (CP), and there may be 12 OFDM symbol for extended CP. Resource assignment in frequency or time domain may be contiguous (i.e. including a starting position+duration) or non-contiguous (i.e. in the form of a bitmap).

The information from the field indicating frequency domain resources and the field indicating time domain resources may be used for resource allocation for SL TB transmission, wherein the time-frequency resource as indicated by the field indicating frequency domain resources and the field indicating frequency domain resources (i.e. the shaded portions of the frequency-time resource table 1302) may be used for sidelink transmission, such as the transmission of the SL TB from the Tx UE to the Rx UE(s) as shown in FIGS. 6 to 12. Further, the field for CRC scrambled RNTI may comprise information identifying an UE such as, for example, an ID of a TX UE. It will be appreciated that the DCI_X in the preceding examples as shown in FIGS. 6 to 12 may be in a same or similar format as that of the DCI_X 1300.

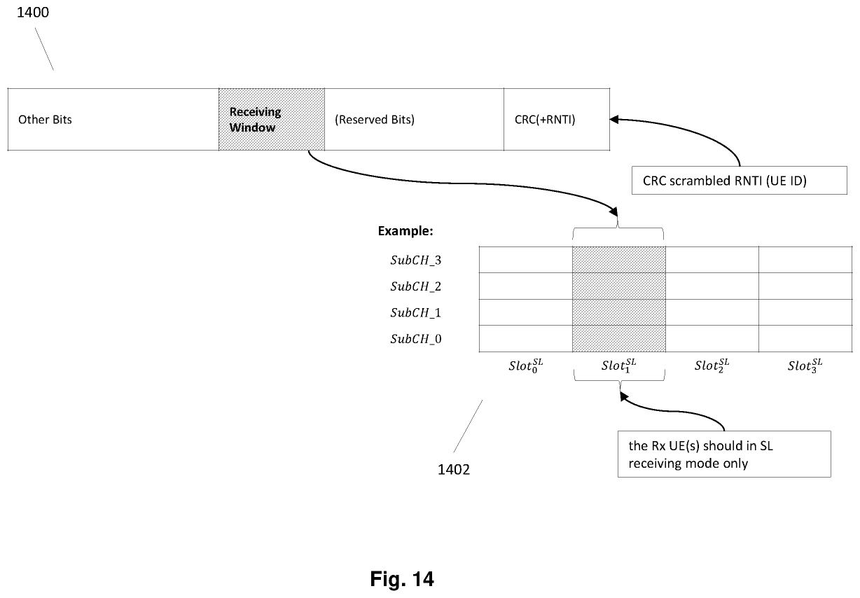

FIG. 14 shows a format of a DCI_Y 1400 according to various embodiments. The DCI_Y 1400 may be transmitted from a gNB or base station to one or more Rx UE(s) in response to receiving scheduling information from the Tx UE, such as shown in steps 1 and 2 of Fig. The DCI_Y 1400 may include (or consist of) an a field indicating receiving window, a field of bits for other purposes, a field of reserved bits, and a field of CRC scrambled by RNTI. The field indicating receiving window may comprise timing information indicating one or more timeslots (i.e. Slot₁^{SL} as shown in frequency-time resource table 1402) in which the Rx UE(s) should be in SL receiving mode only, so that the Rx UE(s) are able to receive the SL TB that would be transmitted from the Tx UE during the time period of Slot₁^{SL}. Further, the CRC scrambled RNTI field may comprise information identifying an UE such as, for example, ID of the Rx UE(s). It will be appreciated that the DCI_Y in the preceding examples as shown in FIGS. 6 to 12 may be in a same or similar format as that of the DCI_Y 1400.

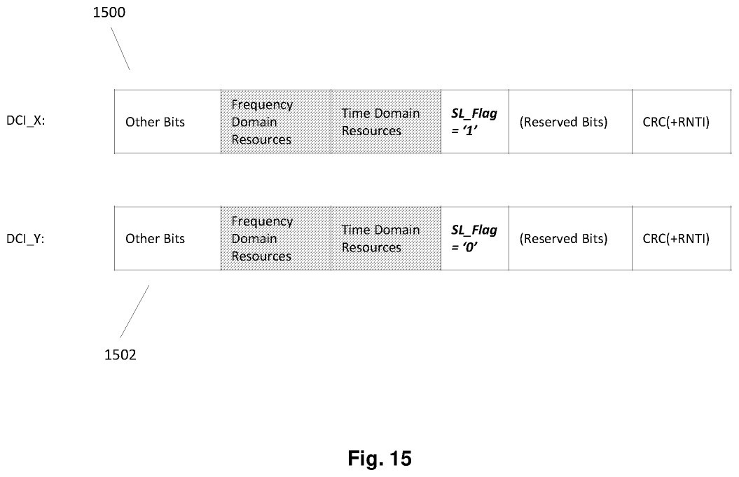

FIG. 15 shows an example of how a receiving window is indicated in a DCI_Y message according to various embodiments. In the present example, DCI_X 1500 and DCI_Y 1502 may include (or consist of) a field indicating frequency domain resources, a field indicating time domain resources, a field of bits for other purposes, a field indicating SL flag, a field of reserved bits, and a field of CRC scrambled by RNTI. The DCI_Y may contain full information of resource assignment (i.e. from the Frequency Domain resources field and the Time Domain Resources field) as DCI_X 1500, and a Receiving Mode Indicator may be defined. The Receiving Mode Indicator may be a 1-bit flag (i.e. SL Flag) to indicate a receiving mode. For example, a Flag with a value of “0” may indicate receiving mode only; while a Flag with a value of “1” may indicate non-receiving mode only (or vice versa). Further, this flag field may be empty in the DCI_X 1500. The flag field together with the full information of resource assignment from the field indicating frequency domain resources and the field indicating time domain resources indicate whether or not a Rx UE is on a receiving mode, as well indicate a receiving window during which the Rx UE is to receive a SL TB transmission from a corresponding Tx UE. It will be appreciated that the DCI_X and DCI_Y in the preceding examples as shown in FIGS. 6 to 12 may be in a same or similar format as that of the DCI_X 1500 and DCI_Y 1502.

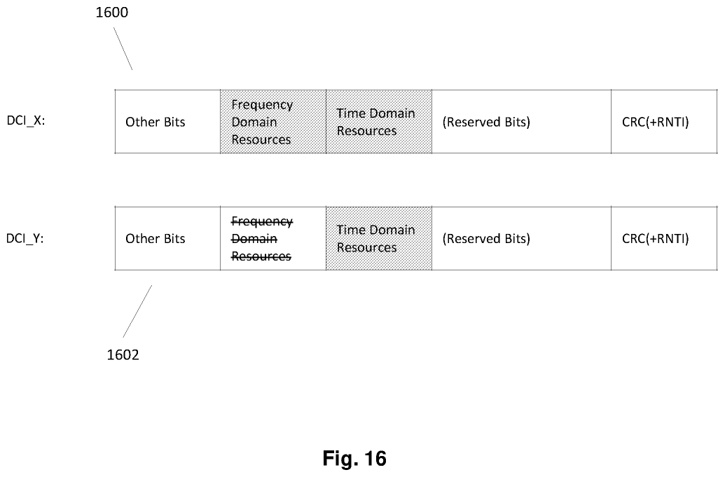

FIG. 16 shows another example of how a receiving window is indicated in a DCI_Y message according to various embodiments. In the present example, DCI_X 1600 may include (or consist of) aa field indicating frequency domain resources, a field indicating time domain resources, a field of bits for other purposes, a field of reserved bits, and a field of CRC scrambled by RNTI. On the other hand, a corresponding DCI_Y 1602 may include (or consist of) a field indicating time domain resources, a field of bits for other purposes, a field of reserved bits, and a field of CRC scrambled by RNTI, such that the field indicating frequency domain resources is omitted in the DCI_Y 1602. Therefore, while DCI_X 1600 may have full time and frequency information of resource assignment (i.e. from the field indicating frequency domain resources and the field indicating time domain resources in the DCI_X 1600) for transmission of a SL RB, DCI_Y 1602 may only contain the timing information of the resource assignment (i.e. from the field indicating time domain resources in the DCI_Y 1602). Further, a receiving mode indicator may be defined as a 1-bit flag that, for example, may be similar to the SL flag field in DCI_X 1500 and DCI_Y 15502. Alternatively, the receiving mode indicator may be implicit, such that the lack of the field indicating frequency domain resources in DCI_Y 1502 implicitly indicates receiving mode only. It will be appreciated that the DCI_X and DCI_Y in the preceding examples as shown in FIGS. 6 to 12 may be in a same or similar format as that of the DCI_X 1600 and DCI_Y 1602.

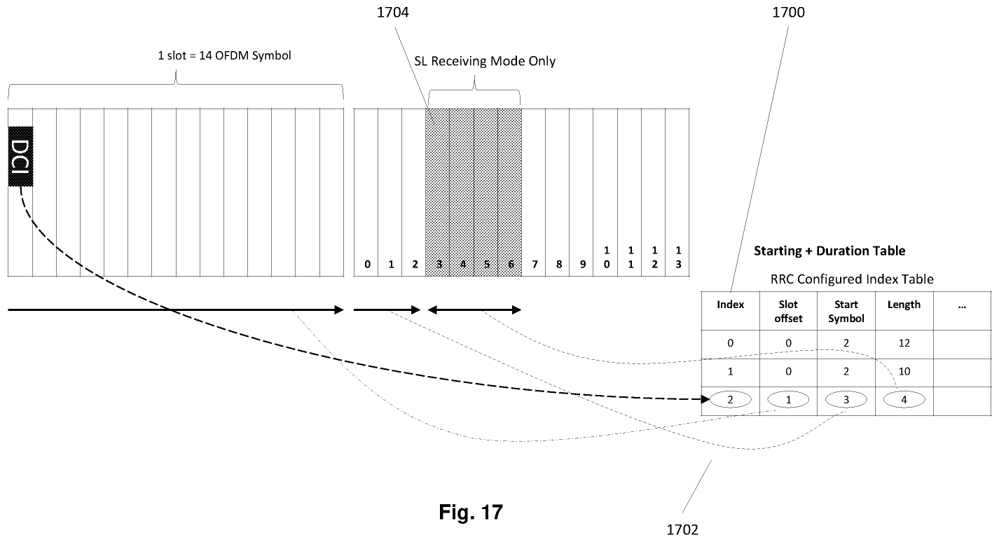

FIG. 17 shows another example of how a receiving window is indicated in a DCI_Y message according to various embodiments. A DCI_Y message may contain an index 1700 for indicating a receiving window during which a Rx UE is on receiving mode to receive a transmission of a SL TB from a Tx UE. The index 1700 may refer to an index table 1702 that may be RCC-configured or pre-configured. For example, the DCI_Y may indicate an index of value ‘2’. Referring to the index table 1702, under index value ‘2’, the receiving window may be determined with at least a slot offset of ‘1’, a start symbol of ‘3’ and a symbol length of ‘4’. Accordingly, the receiving window for receiving the SL TB is scheduled at a next slot (i.e. after a slot offset of ‘1’), starting from symbol ‘3’ of the next slot, continuing for a length of 4 symbols and ending at symbol ‘6’ of the next slot, as shown by shaded region 1704. The index table 1702 may only show the time domain. However, it does not mean that DCI and SL are on the same carrier. Rather, the Rx UE may be on a receiving mode during the receiving window expecting transmission of the SL TB from any carrier. It will be appreciated that the DCI_Y in the preceding examples as shown in FIGS. 6 to 12 may indicate a receiving window in a same format as that of the index 1700 in FIG. 17.

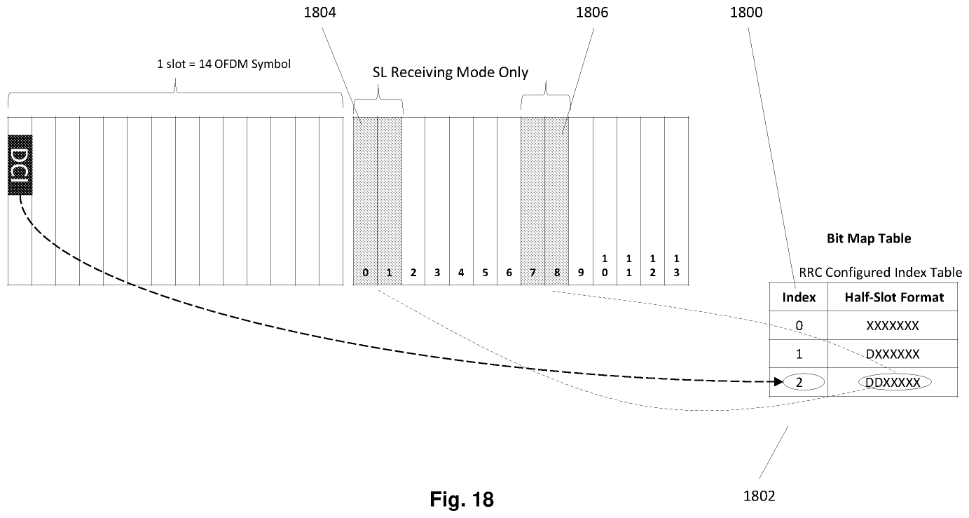

FIG. 18 shows another example of how a receiving window is indicated in a DCI_Y message according to various embodiments. A DCI_Y message may contain an index 1800 for indicating a receiving window during which a Rx UE is on receiving mode to receive a transmission of a SL TB from a Tx UE. The index 1800 may refer to an index/bitmap table 1802 that may be RCC-configured or pre-configured. For example, the DCI_Y may indicate an index of value ‘2’. Referring to the index/bitmap table 1802, under index value ‘2’, the receiving window may be determined based on a corresponding half-slot format i.e. DDXXXXX. Accordingly, the receiving window for receiving the SL TB is scheduled at a 1^{st} and 2^{nd} symbol of every 7 symbols in each slot (represented by symbols ‘DD’ in ‘DDXXXXX’), as shown by shaded regions 1804 and 1806. It will be appreciated that different letters/digits/bits may be used to represent the receiving window or other resource uses in the index/bitmap table 1802. The index/bitmap table 1802 may only show the time domain. However, it does not mean that DCI and SL are on the same carrier. Rather, the Rx UE may be on a receiving mode during the receiving window expecting transmission of the SL TB from any carrier. It will also be appreciated that the DCI _X and DCI_Y in the preceding examples as shown in FIGS. 6 to 12 may indicate a receiving window in a same format as that of the index 1800 in FIG. 18.

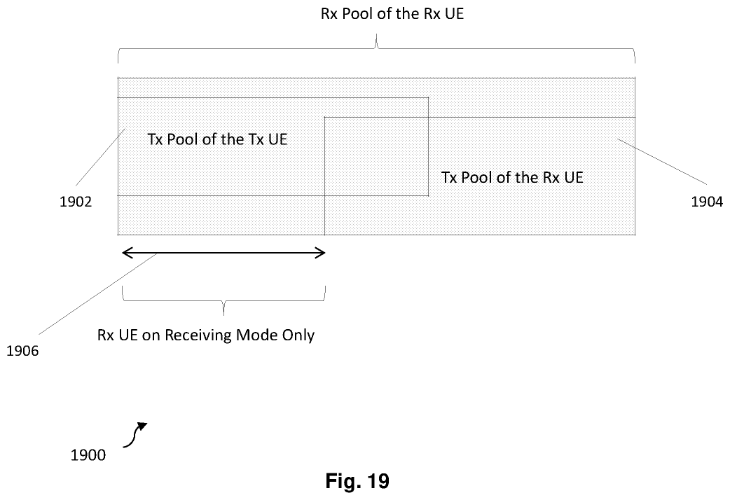

FIG. 19 shows another example of how a receiving window is indicated in a DCI_Y message according to various embodiments. The receiving window for a Rx UE to receive a SL TB transmission from a Tx UE may be indicated in the DCI_Y message via resource pool configuration, for example in a form of a receiving pool 1900 of the Rx UE, by considering timing differences between a transmission pool 1402 of the Tx UE and a transmission pool 1904 of the Rx UE. Generally, the Rx UE should be on receiving mode when the Tx UE is transmitting and not when the Rx UE is transmitting. Therefore, the suitable receiving window may reside in an area of the Rx pool along length 1906. The resource pool configuration may be pre-configured or RRC-configured. It will be appreciated that the DCI_Y in the preceding examples as shown in FIGS. 6 to 12 may indicate a receiving window via resource pool configuration in a same format as shown in FIG. 19.

In various embodiments, behavior of the associated UEs when not receiving the control signaling may be specified. In an embodiment, if the Rx UE misses the transmission of the DCI_Y and regardless of whether the PSCCH transmission is received, the behavior of the Rx UE and Tx UE may be in accordance with legacy UE behavior, wherein it is up to the Tx UE to decide how to proceed with the SL TB. In another embodiment, if the Rx UE missed the PSCCH transmission but receives the DCI_Y correctly, the Rx UE may report to the gNB that an expected SL TB is missed, and the gNB may schedule the Tx UE for a retransmission of the missed SL TB. In an alternative response, the Rx UE may feedback a Non-Acknowledgement (NACK) to the Tx UE on Physical Sidelink Feedback Channel (PSFCH), but only if the Rx UE has related Tx UE information via either DCI_Y or some other source such as Physical Downlink Shared Channel (PDSCH), MAC Control Element (MAC CE), RRC, etc. In another alternative response, the Rx UE may discard the DCI_Y, and it may be up to the Tx UE to decide how to proceed with the SL TB i.e. depending on the PSFCH design. In another embodiment, if the Rx UE missed both the PSCCH and the DCI_Y, the behavior of the Rx UE and Tx UE may be in accordance with legacy UE behavior, wherein it is up to the Tx UE to decide how to proceed with the SL TB.

In various embodiments, blind retransmissions may be waived for mode-1 communications. In various embodiments, the present solution may be applicable to both licensed band and Intelligent Transportation Systems (ITS) band. In various embodiments, the present solution may be applicable to UEs with only mode-1, or with simultaneous mode 1 and 2. In various embodiments, transmission of the DCI_Y to the Rx UE(s) may be periodic (or semi-persistent) when transmission of the DCI _X to the Tx UE is periodic (or semi-persistent). In various embodiments, the Tx UE may request the gNB whether a DCI_Y is needed to be sent to the Rx UE(s). In various embodiments, whether a DCI_Y is needed may be associated with the type of traffic, type of service, or QoS parameter/indicator such as VQI, 5QI, latency, priority, etc.

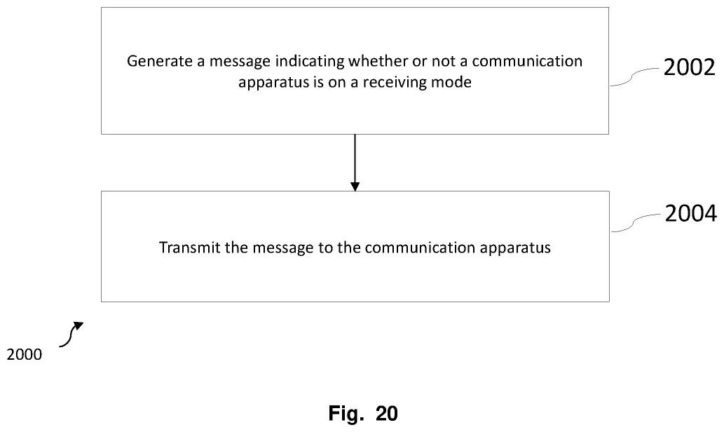

FIG. 20 shows a flow diagram 2000 illustrating a communication method according to various embodiments. In step 2002, a message indicating whether or not a communication apparatus is on a receiving mode may be generated. In step 2004, the message may be transmitted to the communication apparatus.

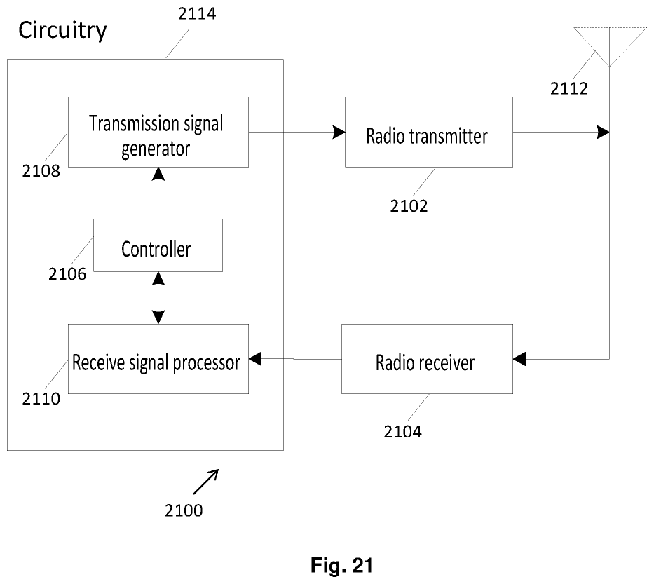

FIG. 21 shows a schematic, partially sectioned view of the communication apparatus 2100 that can be implemented for establishing the V2X communications in accordance with various embodiments as shown in FIGS. 6 to 20. The communication apparatus 1600 may be implemented as a UE or a base station according to various embodiments.

Various functions and operations of the communication apparatus 1600 are arranged into layers in accordance with a hierarchical model. In the model, lower layers report to higher layers and receive instructions therefrom in accordance with 3GPP 5G NR specifications. For the sake of simplicity, details of the hierarchical model are not discussed in the present disclosure.

As shown in FIG. 21, the communication apparatus 2100 may include circuitry 2114, at least one radio transmitter 2102, at least one radio receiver 1604, and at least one antenna 2112 (for the sake of simplicity, only one antenna is depicted in FIG. 21 for illustration purposes). The circuitry 2114 may include at least one controller 2106 for use in software and hardware aided execution of tasks that the at least one controller 2106 is designed to perform, including control of communications with one or more other communication apparatuses in a wireless network. The circuitry 2114 may furthermore include at least one transmission signal generator 1608 and at least one receive signal processor 2110. The at least one controller 2106 may control the at least one transmission signal generator 2108 for generating signals (for example, DCI_X and DCI_Y if the communication apparatus 2100 is a base station, and for example a signal if the communication apparatus 2100 is a UE) to be sent through the at least one radio transmitter 2102 to one or more other communication apparatuses and the at least one receive signal processor 2110 for processing signals (for example DCI_X and DCI_Y if the communication apparatus 2100 is a UE, and for example scheduling information if the communication apparatus 2100 is a base station) received through the at least one radio receiver 2104 from the one or more other communication apparatuses under the control of the at least one controller 2106. The at least one transmission signal generator 2108 and the at least one receive signal processor 2110 may be stand-alone modules of the communication apparatus 2100 that communicate with the at least one controller 2106 for the above-mentioned functions, as shown in FIG. 21. Alternatively, the at least one transmission signal generator 2108 and the at least one receive signal processor 2110 may be included in the at least one controller 2106. It is appreciable to those skilled in the art that the arrangement of these functional modules is flexible and may vary depending on the practical needs and/or requirements. The data processing, storage and other relevant control apparatus can be provided on an appropriate circuit board and/or in chipsets. In various embodiments, when in operation, the at least one radio transmitter 2102, at least one radio receiver 2104, and at least one antenna 2112 may be controlled by the at least one controller 2106.

The communication apparatus 2100, when in operation, provides functions required for implementing DCI in V2X communications. For example, the communication apparatus 2100 may be a UE, and the radio receiver 2104 may, in operation, receive a message indicating whether or not the communication apparatus is on a receiving mode. The transmitter 2102 may, in operation, transmit a signal when the communication apparatus is not on the receiving mode.

The message may indicate a receiving window during which the communication apparatus 2100 is on the receiving mode, and wherein the receiver 2104 is configured to receive a transmission block (TB) when the communication apparatus 1600 is on the receiving mode. The message may be in a format of Downlink Control Information (DCI).

For example, the communication apparatus 2100 may be a base station, and the circuitry 2114 may, in operation, generate a message indicating whether or not a communication apparatus is on a receiving mode. The transmitter 2102 may, in operation, transmit the message to the communication apparatus. The message may be in a format of DCI.

The receiver 2104 may, in operation, receive scheduling information from a transmitting communication apparatus, the scheduling information identifying the communication apparatus. The scheduling information may identify a plurality of communication apparatuses, wherein the message may indicate whether or not the plurality of communication apparatuses are on a receiving mode for a groupcast, and wherein the transmitter 2102 may transmit the message to the plurality of communication apparatuses.

The receiver 2104 may, in operation, receive scheduling information from a transmitting communication apparatus, the scheduling information identifying the communication apparatus. The scheduling information may identify a plurality of communication apparatuses, wherein the message may indicate whether or not the plurality of communication apparatuses are on a receiving mode for a broadcast, and wherein the transmitter 2102 may transmit the message to the plurality of communication apparatuses.

The transmitter 2102 may be further configured to transmit a DCI to the transmitting communication apparatus, the DCI indicating that the message has been sent to the communication apparatus.

The message may indicate a receiving window during which the communication apparatus is on the receiving mode, wherein the communication apparatus is configured to receive a transmission block (TB) during the receiving window. The receiving window may comprise frequency and timing information of resource assignment for receiving the TB. The receiving window may comprise an index for receiving the TB. The receiving window may comprise resource pool configuration for receiving the TB. The receiving window may comprise full information on resource allocation, modulation and coding scheme (MCS) for receiving the TB, and wherein transmission of Sidelink control information (SCI) message on a Physical Sidelink Control Channel (PSCCH) for the TB is waived.

As described above, the embodiments of the present disclosure provides an advanced communication system, communication methods and communication apparatuses that implements DCI for V2X communication apparatuses that advantageously allow the mitigation or avoidance of missed SL TB transmissions.

The present disclosure can be realized by software, hardware, or software in cooperation with hardware. Each functional block used in the description of each embodiment described above can be partly or entirely realized by an LSI such as an integrated circuit, and each process described in the each embodiment may be controlled partly or entirely by the same LSI or a combination of LSIs. The LSI may be individually formed as chips, or one chip may be formed so as to include a part or all of the functional blocks. The LSI may include a data input and output coupled thereto. The LSI here may be referred to as an IC, a system LSI, a super LSI, or an ultra LSI depending on a difference in the degree of integration. However, the technique of implementing an integrated circuit is not limited to the LSI and may be realized by using a dedicated circuit, a general-purpose processor, or a special-purpose processor. In addition, a FPGA (Field Programmable Gate Array) that can be programmed after the manufacture of the LSI or a reconfigurable processor in which the connections and the settings of circuit cells disposed inside the LSI can be reconfigured may be used. The present disclosure can be realized as digital processing or analogue processing. If future integrated circuit technology replaces LSIs as a result of the advancement of semiconductor technology or other derivative technology, the functional blocks could be integrated using the future integrated circuit technology. Biotechnology can also be applied.

The present disclosure can be realized by any kind of apparatus, device or system having a function of communication, which is referred as a communication apparatus.

The communication apparatus may comprise a transceiver and processing/control circuitry. The transceiver may comprise and/or function as a receiver and a transmitter. The transceiver, as the transmitter and receiver, may include an RF (radio frequency) module including amplifiers, RF modulators/demodulators and the like, and one or more antennas.

Some non-limiting examples of such communication apparatus include a phone (e.g, cellular (cell) phone, smart phone), a tablet, a personal computer (PC) (e.g, laptop, desktop, netbook), a camera (e.g, digital still/video camera), a digital player (digital audio/video player), a wearable device (e.g, wearable camera, smart watch, tracking device), a game console, a digital book reader, a telehealth/telemedicine (remote health and medicine) device, and a vehicle providing communication functionality (e.g., automotive, airplane, ship), and various combinations thereof.

The communication apparatus is not limited to be portable or movable, and may also include any kind of apparatus, device or system being non-portable or stationary, such as a smart home device (e.g, an appliance, lighting, smart meter, control panel), a vending machine, and any other “things” in a network of an “Internet of Things (IoT)”.

The communication may include exchanging data through, for example, a cellular system, a wireless LAN system, a satellite system, etc., and various combinations thereof.

The communication apparatus may comprise a device such as a controller or a sensor which is coupled to a communication device performing a function of communication described in the present disclosure. For example, the communication apparatus may comprise a controller or a sensor that generates control signals or data signals which are used by a communication device performing a communication function of the communication apparatus.

The communication apparatus also may include an infrastructure facility, such as a base station, an access point, and any other apparatus, device or system that communicates with or controls apparatuses such as those in the above non-limiting examples.

It will be understood that while some properties of the various embodiments have been described with reference to a device, corresponding properties also apply to the methods of various embodiments, and vice versa.

It will be appreciated by a person skilled in the art that numerous variations and/or modifications may be made to the present disclosure as shown in the specific embodiments without departing from the spirit or scope of the disclosure as broadly described. The present embodiments are, therefore, to be considered in all respects illustrative and not restrictive.

1. A communication apparatus comprising:
a receiver, which, in operation, receives a message indicating whether or not the communication apparatus is on a receiving mode; and
a transmitter, which, in operation, transmits a signal when the communication apparatus is not on the receiving mode.

2. The communication apparatus according to claim 1, wherein the message indicates a receiving window during which the communication apparatus is on the receiving mode, and wherein the receiver is configured to receive a transmission block (TB) when the communication apparatus is on the receiving mode.

3. The communication apparatus according to claim 1, wherein the message is in a format of Downlink Control Information (DCI).

4. A base station comprising:
circuitry, which, in operation, generates a message indicating whether or not a communication apparatus is on a receiving mode; and
a transmitter, which, in operation, transmits the message to the communication apparatus.

5. The base station according to claim 4, further comprising a receiver, which, in operation, receives scheduling information from a transmitting communication apparatus, the scheduling information identifying the communication apparatus.

6. The base station according to claim 5, wherein the scheduling information identifies a plurality of communication apparatuses, wherein the message indicates whether or not the plurality of communication apparatuses are on a receiving mode for a groupcast, and wherein the transmitter transmits the message to the plurality of communication apparatuses.

7. The base station according to claim 5, wherein the scheduling information identifies a plurality of communication apparatuses, wherein the message indicates whether or not the plurality of communication apparatuses are on a receiving mode for a broadcast, and wherein the transmitter transmits the message to the plurality of communication apparatuses.

8. The base station according to claim 5, wherein the transmitter is further configured to transmit a DCI to the transmitting communication apparatus, the DCI indicating that the message has been sent to the communication apparatus.

9. The base station according to claim 4, wherein the message indicates a receiving window during which the communication apparatus is on the receiving mode, wherein the communication apparatus is configured to receive a transmission block (TB) during the receiving window.

10. The base station according to claim 9, wherein the receiving window comprises frequency and timing information of resource assignment for receiving the TB.

11. The base station according to claim 9, wherein the receiving window comprises an index for receiving the TB.

12. The base station according to claim 9, wherein the receiving window comprises resource pool configuration for receiving the TB.

13. The base station according to claim 9, wherein the receiving window comprises full information on resource allocation, modulation and coding scheme (MCS) for receiving the TB, and wherein transmission of Sidelink control information (SCI) message on a Physical Sidelink Control Channel (PSCCH) for the TB is waived.

14. The base station according to claim 4, wherein the message is in a format of DCI.

15. A communication method comprising:
generating a message indicating whether or not a communication apparatus is on a receiving mode; and
transmitting the message to the communication apparatus.
